(19) United States
(12) Patent Application Publication
(10) Pub. No.: US 2002/0013790 A1
(43) Pub. Date: Jan. 31, 2002

(54) System and method for converting data in a first hierarchical data scheme into a second hierarchical data scheme

(75) Inventor: Kirstan Anderson Vandersluis, Colorado Springs, CO (US)

Correspondence Address: Law Offices of Dale B. Halling, Suite 311, 24 South Weber St., Colorado Springs, CO, 80903, US

(73) Assignee: X-Aware, Inc.

(21) Appl. No.: 09/900,079

(22) Filed: Jul. 6, 2001

Related U.S. Application Data
(60) Provisional application No. 60/216,802, filed on Jul. 7, 2000.

(51) Int. Cl. G06F 17/21

(52) U.S. Cl. 707/514

(57) ABSTRACT

A system (20) for converting data in a first hierarchical data scheme into a second hierarchical data scheme includes a template (22) that defines the second hierarchical data scheme. A dynamic data generation module (24) is contained in the template (22). A data source (26) is in communication with the dynamic data generation module (24) and contains data in the first hierarchical data scheme. The template (22) provides a format for mapping the data between the two data schemes.

### RELATED APPLICATION

This patent claims priority on provisional patent application 60/216,802 filed Jul. 7, 2000, which is hereby incorporated by reference.

### FIELD OF THE INVENTION

The present invention relates generally to the field of data format conversion and more particularly to a system and method for converting data in a first hierarchical data scheme into a second hierarchical scheme.

### BACKGROUND OF THE INVENTION

Large corporations commonly have many different data sources for storing their information. Each of these data sources may contain data in different formats or hierarchical data schemes. For instance, a corporation may have data in a standard database format of a mainframe computer. Another data source may use a relational database data scheme. Another data source may use a hierarchical data store such as object database or an XML database. If the company has more than one data source using a relational database the data schemes may not be compatible. In addition, many companies are now using eXtensible Markup Language (XML) files or databases to share information with their customers and suppliers. Since the data is in these different hierarchical data schemes, it cannot be easily shared between data sources. As a result, companies generally have two choices: 1) repeat the same data across multiple data sources to accommodate the different data schemes or 2) write expensive custom software to convert between the data schemes. Repeating the same data is costly and an inefficient use of human and computer resources. In addition, it leads to problems with inconsistencies between the data sets. The second solution is expensive, time consuming and generally requires a small army of programmers to maintain.

Thus there exists a need for system and method that provides a simple solution for converting data in a first hierarchical data scheme into a second hierarchical data scheme. Note that the phrase hierarchical data scheme includes, standard databases, XML files, XML databases, relational databases, self describing databases, flat files, spreadsheets, flat self describing files and object oriented databases and other systems that group data and its context.

### BRIEF DESCRIPTION OF THE DRAWINGS

FIG. 1 is a block diagram of a system for converting data in a first hierarchical data scheme into a second hierarchical data scheme in accordance with one embodiment of the invention;

FIG. 2 is a block diagram of a system for converting data in a first hierarchical data scheme into a second hierarchical data scheme in accordance with one embodiment of the invention;

FIG. 3 is a flow chart of the steps used in a method of converting data in a first hierarchical data scheme into a second hierarchical data scheme in accordance with one embodiment of the invention;

FIGS. 4 & 5 are a flow chart of the steps used in a method of converting data in a first hierarchical data scheme into a second hierarchical data scheme in accordance with one embodiment of the invention;

FIGS. 6 & 7 are a flow chart of the steps used in a method of converting data in a first hierarchical data scheme into a second hierarchical data scheme in accordance with one embodiment of the invention;

FIG. 8 is a flow chart of the steps used in a method of converting data in a first hierarchical data scheme into a second hierarchical data scheme in accordance with one embodiment of the invention FIG. 9 is a flow chart of the steps used in converting from a hierarchical data scheme to a XML data scheme in accordance with one embodiment of the invention;

FIG. 10 is a flow chart of the steps used in converting from a XML data scheme to a hierarchical data scheme in accordance with one embodiment of the invention;

FIG. 11 is an example of a template used in converting data from a first hierarchical data scheme into a second hierarchical data scheme in accordance with one embodiment of the invention;

FIG. 12 is a screen shot from a development system used in converting data from a first hierarchical data scheme into a second hierarchical data scheme in accordance with one embodiment of the invention;

FIG. 13 is a screen shot of a wizard used to define a query type in accordance with one embodiment of the invention;

FIG. 14 is a screen shot of a data mapping wizard in accordance with one embodiment of the invention; and

FIG. 15 is a screen shot a template being processed in a developer module in accordance with one embodiment of the invention.

### DETAILED DESCRIPTION OF THE DRAWINGS

A system for converting data in a first hierarchical data scheme into a second hierarchical data scheme includes a template that defines the second hierarchical data scheme. A dynamic data generation module is contained in the template. A data source is in communication with the dynamic data generation module and contains data in the first hierarchical data scheme. The template provides a format for mapping the data between the two data schemes. In one embodiment there are several dynamic data generation modules. These modules allow the template to pull (push) different sets of data from (into) a variety of different sources. In one embodiment, the system allows a data manager with very little training and time to design a system to create an XML file from a variety of back office data systems or to push an XML file's data into the back office data systems. The template allows these two very different processes to be performed using the same basic steps in the development mode.

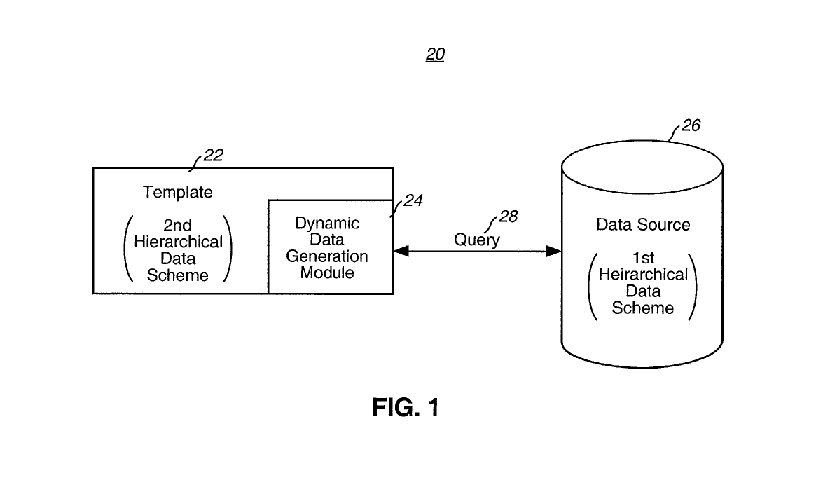

FIG. 1 is a block diagram of a system 20 for converting data in a first hierarchical data scheme into a second hierarchical data scheme in accordance with one embodiment of the invention. The system 20 includes a template 22 that defines a second hierarchical data scheme. In one embodiment the second hierarchical data scheme may be a sample extensible markup language file, an XML target format template, a extensible markup language document type definition or an extensible markup language schema (See the web site for World Wide Web Consortium). These examples of templates are exemplary and not limiting. A dynamic data generation module 24 is contained in the template 22. A data source 26 is in communication with the dynamic data generation module 24. The data source 26 contains data in the first hierarchical data scheme. The dynamic data generation module 24 includes a query 28 to the data source 26 and driver for connecting to the data source 26. The results of the query, in one embodiment, place the acquired data in the appropriate part of the template. In another embodiment, the query takes the data from the appropriate part of the template and places it in the data store (26). In this way the data is converted from the first hierarchical data scheme to the second hierarchical data scheme or vice versa. In one embodiment, the first hierarchical data scheme may be an extensible markup language scheme, a relational database, a non-relational database, an extensible markup language database, or a self describing database. The second hierarchical data scheme, in one embodiment, may be an extensible markup language scheme, a relational database, a non-relational database, an extensible markup language database, or a self describing database. Note that the first and second hierarchical data scheme may be in the same class (e.g., both relational databases) but have a different data scheme.

In complex data conversion cases, it is necessary to define more than one set of templates, so that the data conversion for the whole is broken down into multiple data conversions on sets. In these cases, the first set of templates converts one subset of data, and additional sets of templates are used to convert the remaining subsets of data, with each set of templates operating as described above.

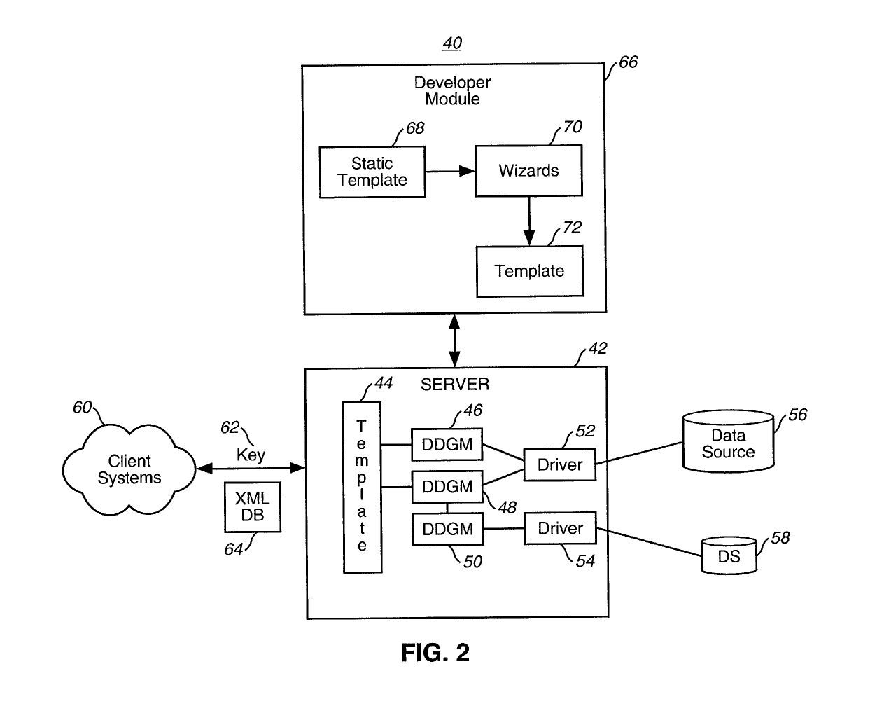

FIG. 2 is a block diagram of a system 40 for converting data in a first hierarchical data scheme into a second hierarchical data scheme in accordance with one embodiment of the invention. The system 40 has a server 42 that contains a template 44. The template 44 is connected to (or contains) several dynamic data generation modules (DDGM) 46, 48. Note that a DDGM 48 may call another DDGM 50 to complete its task. The DDGMs 46, 48, 50 are connected to a pair of drivers 52, 54. The pair of drivers 52, 54 are connected to a pair of data sources (DS) 56, 58. The template 44 is connected to a client system 60. In one embodiment the client transmits a key and an instruction 62 to the server 42 and receives an XML document related to the key 62. In another embodiment, the client system 60 transmits an XML document 64 such as an order to the server 42 and the order is translated and different portions are sent to the different data sources 56, 58. In yet another embodiment, client system 60 sends a key 62 to the server 42 and receives data 64. Note that the template 44, DDGMs 46, 48, 50 and drivers 52, 54 form a dynamic data conversion program.

The system 40 also includes a developer module 66 connected to the server 42. The developer module 66 has a static template 68 such as a sample XML document, a static extensible markup language document, an XML schema or an XML document type definition (DTD). A wizard 70 or set of wizards walk a user through the process of converting the static template 68 into a dynamic template 72 that is then published to a server 42. The wizards 42 also generate the DDGMs and the drivers. The system 40 may be used to convert between any two hierarchical data schemes. In one embodiment, when a user wants to convert between two data schemes neither of which are XML an intermediate XML document is created. Thus the system may be used to convert back office data systems into an XML format, or convert an XML formatted order into the format expected by the back office systems (processing systems) or to synchronize two different data systems. This list is suggestive of the potential applications of present invention but not limiting. One feature that makes the present invention so useful is that the development process is simple and is very similar for converting from back office data sources to XML or from XML to back office systems. Both processes use an XML template and the steps are essentially the same. Detailed examples of the development process for both cases are provided in the provisional application (60/216,802, section 3 of the user's manual) and will not be repeated herein. Note that in the user's manual (provisional) the template is equivalent to a “BizDoc”; a dynamic data generation module (DDGM) is equivalent to a BizComponent (BizComp); and BizDriver is equivalent to a driver.

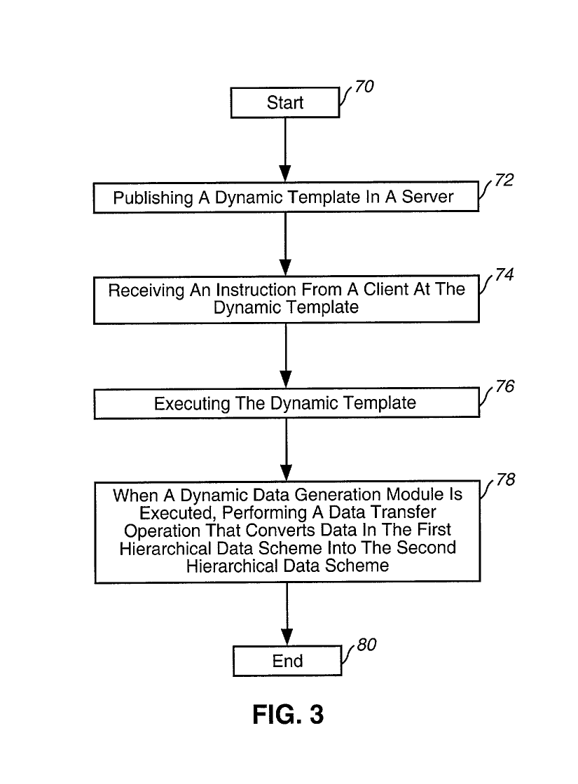

FIG. 3 is a flow chart of the steps used in a method of converting data in a first hierarchical data scheme into a second hierarchical data scheme in accordance with one embodiment of the invention. The process starts, step 70, by publishing a dynamic template in a server at step 72. An instruction is received from a client at the dynamic template at step 74. The dynamic template is executed at step 76. When a dynamic data generation module is executed at step 78, a data transfer operation is performed that converts data in the first hierarchical data scheme into the second hierarchical data scheme which ends the process at step 80. In one embodiment, a template is received as the first step in creating the dynamic template. Next it is determined for each element of the template if a dynamically generated data is required. When dynamically generated data is required, a data source for obtaining the dynamically generated data is received. In other words the user selects a data source in the developer module from which the data is to be obtained. Note that this is done for every element of the template. As a result, the dynamically generated data is treated as different sets of data. In fact, a single data set may require pulling (pushing) data from a variety of data sources or processing resources. In one embodiment, a data mapping is received between the first hierarchical data scheme and the second hierarchical data scheme. An example of data mapping screen is shown in one of the later figures. The data mapping correlates categories of data in the first data scheme to categories of data in the second data scheme. The data mapping screen allows the user to correlate the different categories easily. In one embodiment, a key is associated with the data mapping. The key determines which record of data is desired by the template.

Note that in one embodiment when the first hierarchical data scheme and the second hierarchical data scheme are a non-extensible markup language, a first data mapping is created between the first hierarchical data scheme and an intermediate extensible markup scheme. A second data mapping is created between the intermediate extensible markup scheme and the second hierarchical data scheme. In other words the data is transformed into an XML format and then transformed to the second data format.

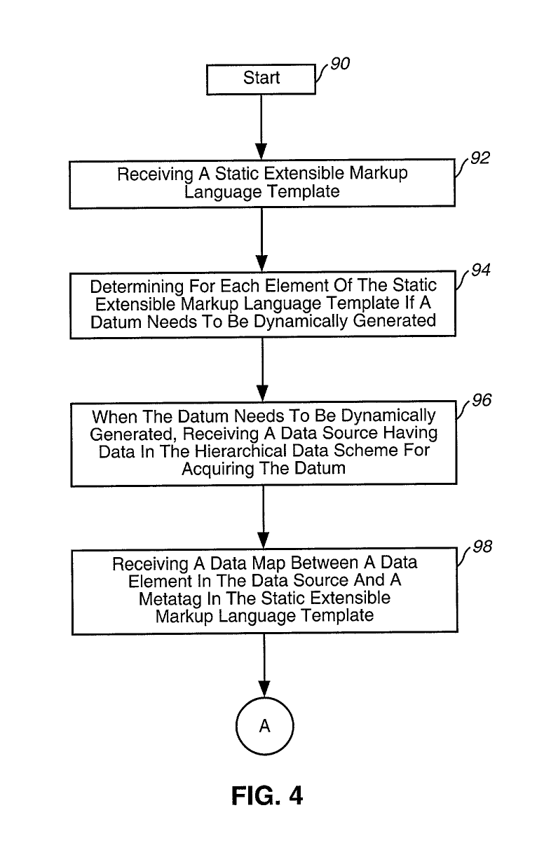

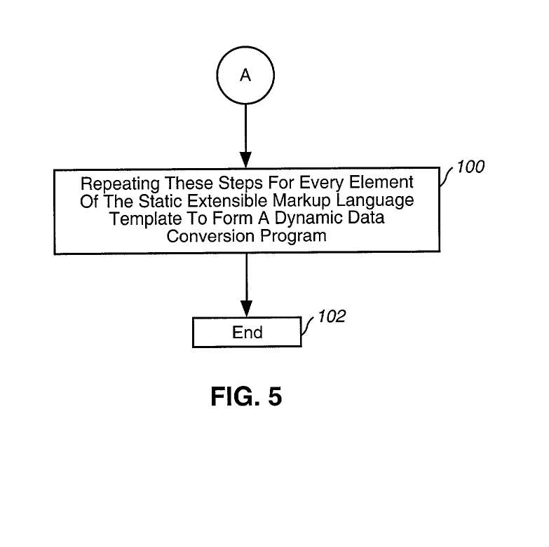

FIGS. 4 & 5 are a flow chart of the steps used in a method of converting data in a first hierarchical data scheme into a second hierarchical data scheme in accordance with one embodiment of the invention. The process starts, step 90, by receiving a static extensible markup language template at step 92. Next it is determined for each element of the static extensible markup language if a datum needs to be dynamically generated at step 94. When the datum needs to be dynamically generated, a data source is received having data in the hierarchical data scheme for acquiring the datum at step 96. A data map between a data element in the data source and a metatag in the static extensible markup language template is received at step 98. At step 100 the steps are repeated for every element of the static extensible markup language template to form a dynamic data conversion program which ends the process at step 102. In one embodiment the process of creating the dynamic data conversion program includes the step of defining an input parameter. In another embodiment, the step of receiving the data source includes the step of receiving a driver. In another embodiment, the step of receiving a data source includes the step of generating a query to the data source. Note a query can include both receiving data from the data source and inputting data into the data source. In one embodiment, a screen is received that has a list of elements from the data source and a list of metatags from the static extensible markup language template. In another embodiment, the developer module displays an incomplete version of a dynamic markup language template. This incomplete version shows a static element in a first color (e.g., red) and a dynamic element in a second color (e.g., green). This provides a quick visual clue as to which elements still require mapping. Commonly the static elements may require a separate DDGM to convert them to a dynamic element.

Once the dynamic data generation program is complete it is published to a server. When a query is received at the server for the dynamic data conversion program, the program is executed to form an extensible markup language document.

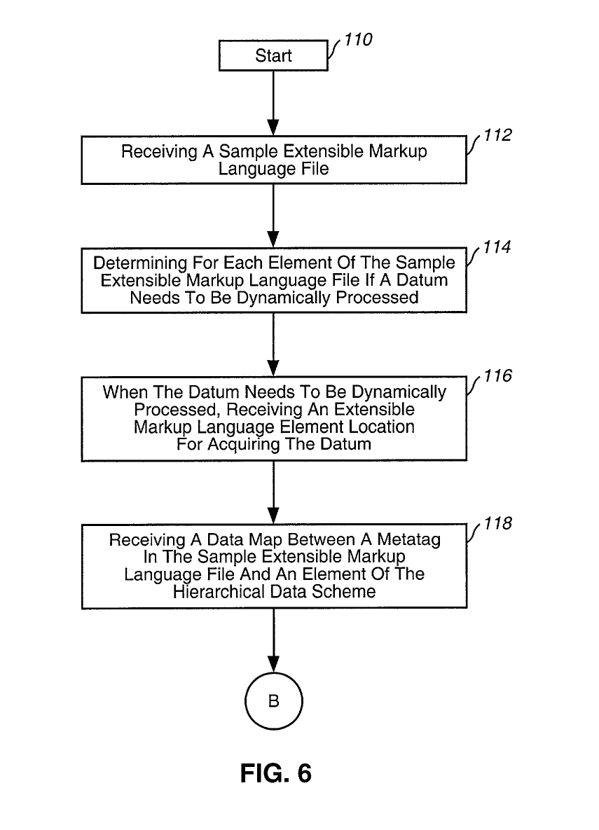

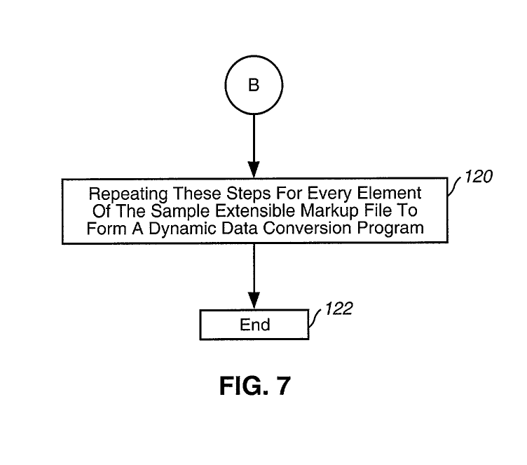

FIGS. 6 & 7 are a flow chart of the steps used in a method of converting data in a first hierarchical data scheme into a second hierarchical data scheme in accordance with one embodiment of the invention. The process starts, step 110, by receiving a sample extensible markup language file at step 112. Next it is determined for each element of the sample extensible markup language file if a datum needs to be dynamically processed at step 114. When the datum needs to be dynamically processed, an extensible markup language element location for acquiring the datum is received at step 116. A data map between a metatag in the sample extensible markup language file and an element of the hierarchical data scheme is received at step 118. At step 120 these steps are repeated for every element of the sample extensible markup file to form a dynamic data conversion program which ends the process at step 122. Note the similarity between this flow chart and the flow chart of FIGS. 4 & 5 even though one process is converting data into XML and the other process is converting XML into a back office database format. This similarity reduces the time necessary to learn the development processes. In one embodiment, the step of receiving a sample XML file includes the step of defining a key. In another embodiment, the step of receiving a data map further includes the steps of receiving a query type and generating a query. Note the query type may be an insert or update or insert update query type.

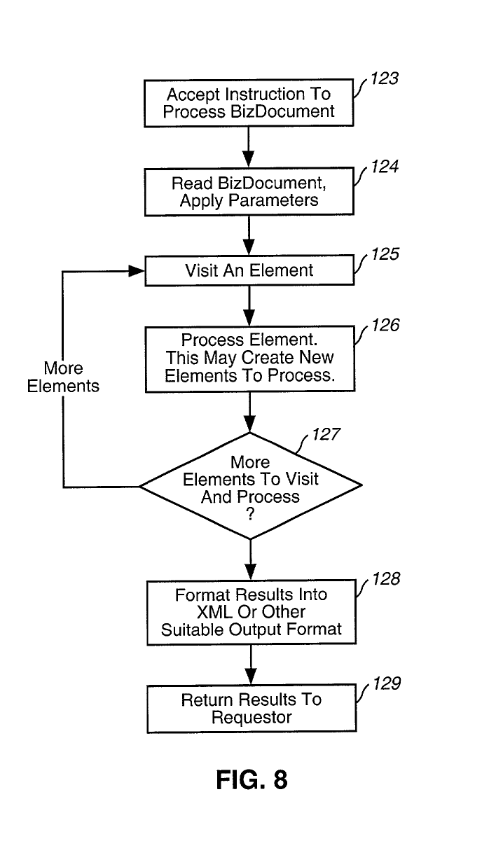

FIG. 8 is a flow chart of the steps used in a method of converting data in a first hierarchical data scheme into a second hierarchical data scheme in accordance with one embodiment of the invention. The method starts by receiving an instruction at step 123. An instruction may include the identity of BizDocument, parameters, and/or input data to be processed. Next the BizDocument is read and the parameters are applied at step 124. Apply parameters means replacing any references to the parameter with the actual value passed in for the parameter. At step 125 the next element in the BizDocument is selected. At step 126 the element is processed. This may create new elements that are selected in order by the process. Any newly generated elements form the BizComponent processor will be visited in due course, which is called “runtime drill-down”. In addition, general -purpose logic is supported to allow logical control of the processing. Any element that is static is not transformed and becomes part of the results at step 128. This process is described in more detail in FIGS. 8 & 9. At step 127 the process determines any more elements that haven't been processed. If more elements require processing, the method returns to step 125. If no elements require further processing, the results are formatted into XML or any other suitable output format at step 128. The results are returned to the requester at step 129. Note an element may reference an inbound or outbound BizComponent, in which case an “instruction” is sent ot the appropriate BizComponent processor. The instruction may include parameters and/or data from any place in the BizDocument in its current processing state, including data generated from other BizComponents.

FIG. 9 is a flow chart of the steps used in converting from a hierarchical data scheme to a XML data scheme in accordance with one embodiment of the invention. This figure shows the part of the process performed by the BizComponent. The process starts by receiving a request at step 130. Next the parameters are applied at step 132. The parameters may include a key that defines the particular set of data desired. Next a command is executed to get data at step 134. The data set is received at step 136. The template is applied that transforms the received data into XML elements at step 138. The template provides the desired XML format and specifies the locations for the received data. Note that the template may include references to other BizComponents, which will be executed later by the BizDocument. The XML elements are added to the BizComponent output set at step 140. At step 142 it is determined if the process is done fetching data. When the process is not done fetching data, the process returns to step 136. When the process is done fetching data, the process returns to the BizDocument for further processing, including runtime drill-down at step 144.

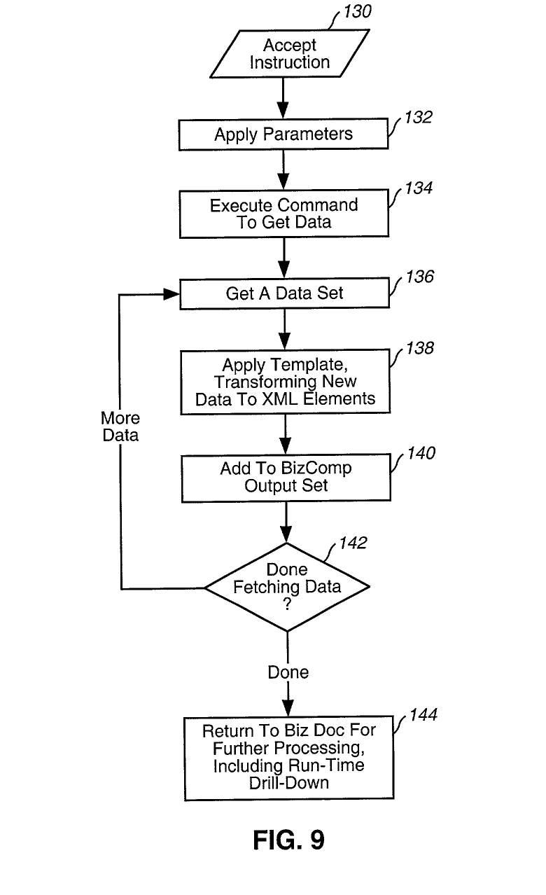

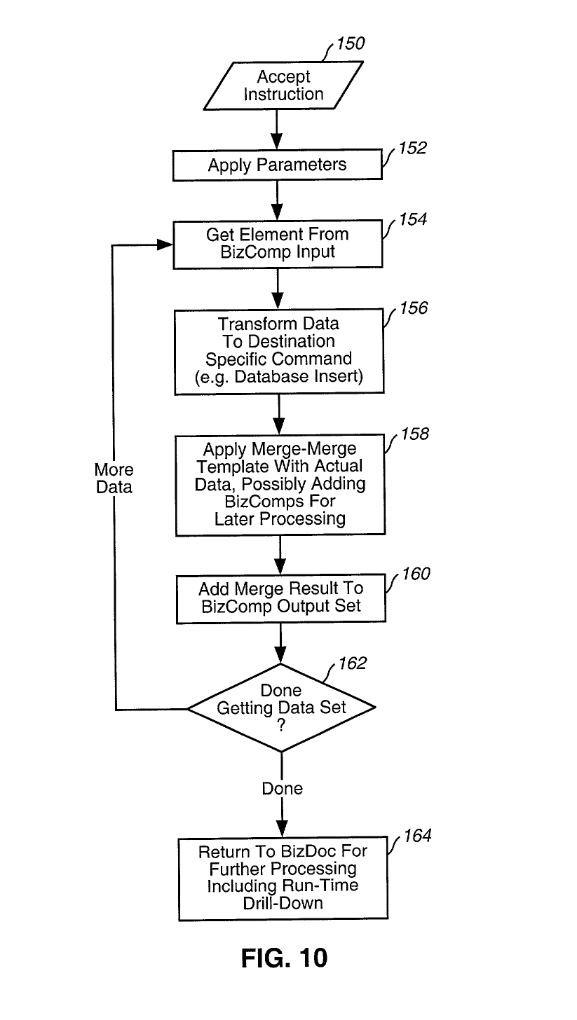

FIG. 10 is a flow chart of the steps used in converting from a XML data scheme to a hierarchical data scheme in accordance with one embodiment of the invention. This figure shows the part of the process performed by the BizComponent. The process starts by accepting an instruction, which includes an input element data set at step 150. Next the parameters are applied at step 152. Next an element from the input data set is received from the BizComponent at step 154. The element is transformed to the destination specific command at step 156. The destination specific command may be a database insert for example. A merge operation is then applied at step 158 to the input element and the result added to the BizComponent's output set. The merge operation merges the input element with the BizComponent template, which is of substantially the same format and structure as the input element, but which may include additional elements. In particular, if the template contains additional BizComponent references, each such reference appears in the current BizComponent's output set, ready to be processed later by the BizDocument. In this way, a BizComponent processes all portions of the element that it can, and defers processing of remaining portions of the element to other BizComponents. The merge result is added to the BizComponent output set at step 160. At step 162 it is determined if the method is done processing the input element set. When the method is not done processing the input element set, it returns to step 154. When the method is done processing the input element set, the process returns to the BizDocument for further processing including run-time drill-down at step 164.

It will be obvious to those skilled in the art that the BizComponent operations of FIGS. 9 & 10 may be combined into a single operation. By combining these operations it provides additional flexibility to the BizComponent. For example it provides the option of selecting a merge operation or template operation as required by the application.

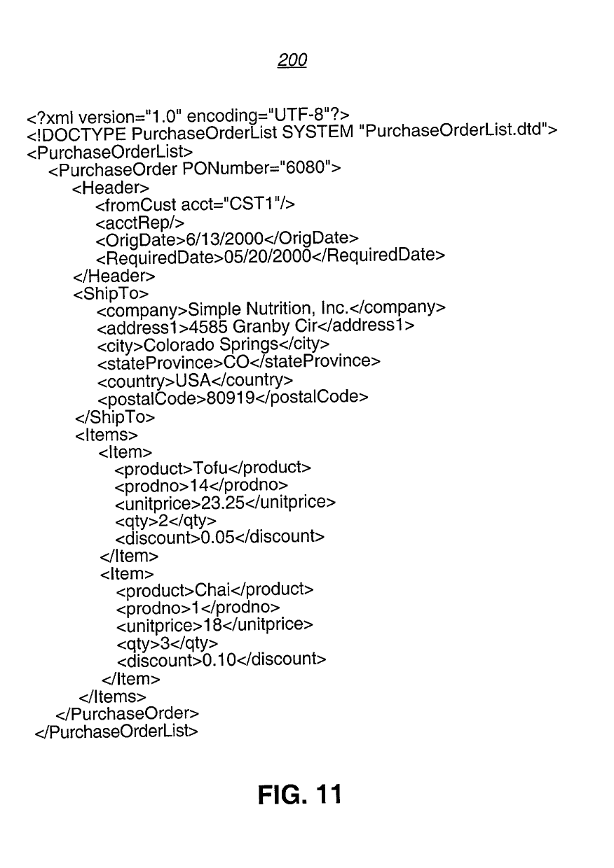

FIG. 11 is an example of a template 200 used in converting data from a first hierarchical data scheme into a second hierarchical data scheme in accordance with one embodiment of the invention. The template 200 is an XML sample document showing a purchase order list. The list will be sorted by purchase order numbers and includes company name and address, ship to information and items in the purchase order. It is possible that the item information may be stored in different databases and in different physical locations. If so this will require separate DDGMs. However, the separate DDGMs allow the user to group data and therefore break the translation process down into smaller problems.

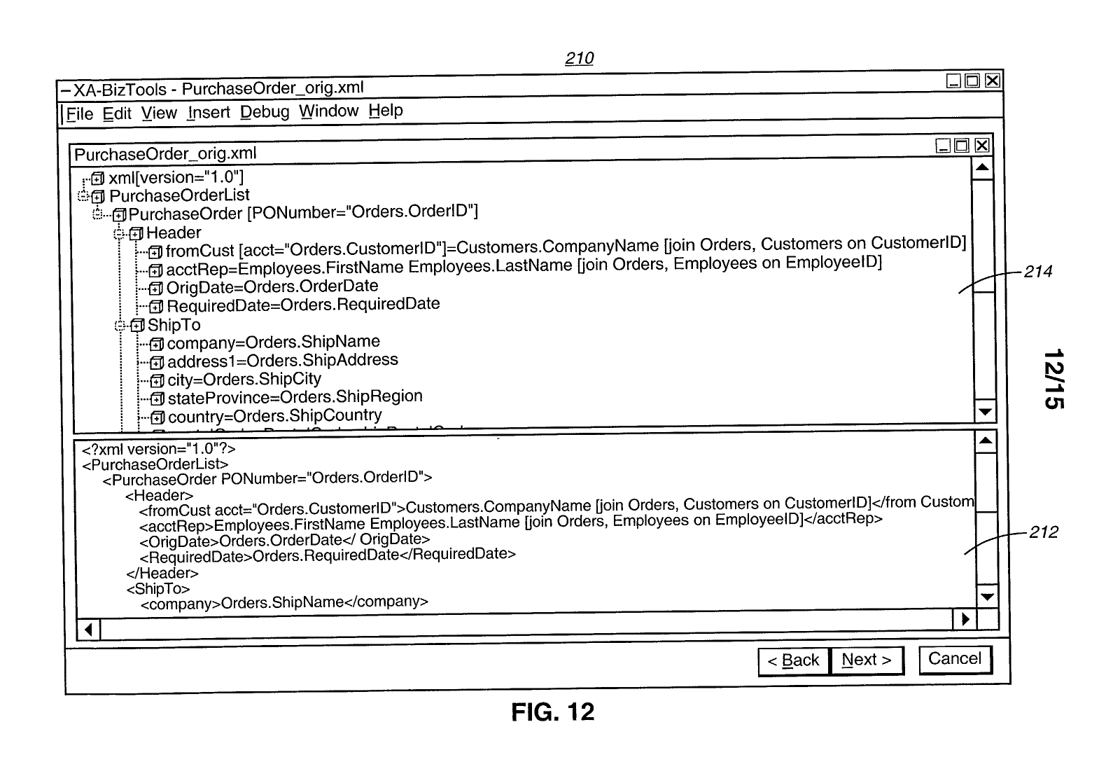

FIG. 12 is a screen shot 210 from a development system used in converting data from a first hierarchical data scheme into a second hierarchical data scheme in accordance with one embodiment of the invention. Notice that the lower half of the screen 212 is the same XML sample as shown in FIG. 11. The top half of the screen 214 is the same document shown in a tree structure.

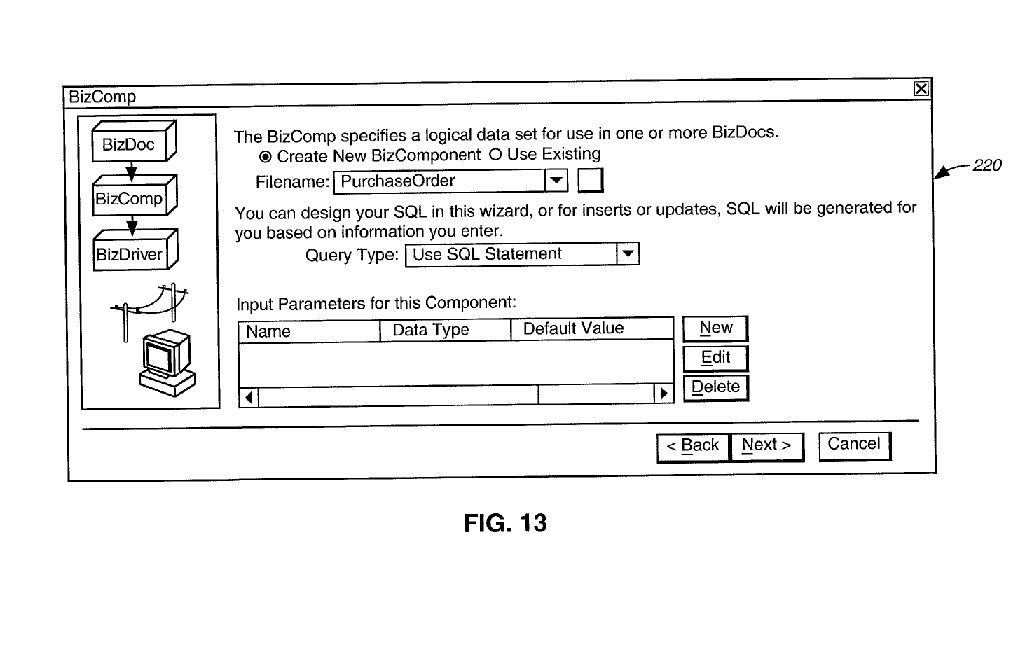

FIG. 13 is a screen shot of a wizard 220 used to define a query type in accordance with one embodiment of the invention. This wizard screen shot shows that the query type is a SQL (Standard Query Language) query. Note that below this is an area to fill in an input parameter. The input parameter is passed from one DDGM to another DDGM to identify the particular set of data desired. For instance, we might desire purchase order information from XYZ Corporation. The initial input parameter might be XYZ Corporation. However, XYZ might have numerous purchase orders, so the next DDGM might have PO number as the input parameter.

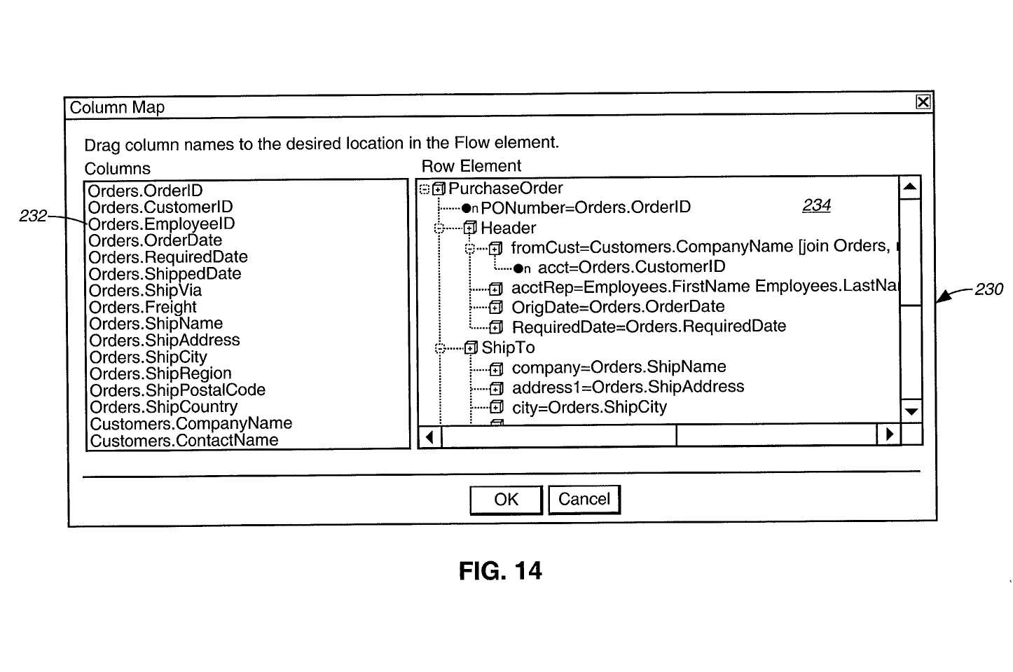

FIG. 14 is a screen shot of a data mapping wizard 230 in accordance with one embodiment of the invention. The left side 232 of the screen shows standard column elements that might be found in a relational database and the right side 234 shows the metatags (elements) of the XML sample. The developer just uses a drag a drop technique to correlate these items.

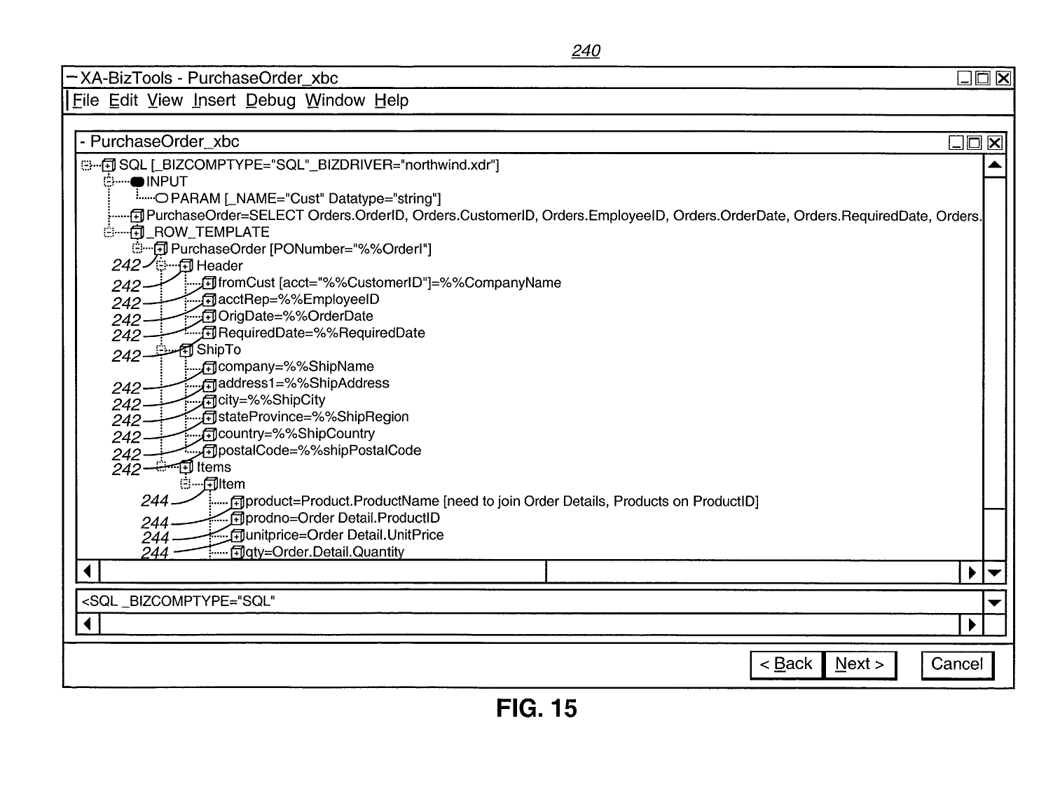

FIG. 15 is a screen shot 240 a template being processed in a developer module in accordance with one embodiment of the invention. This template 240 shows dynamic elements 242 in a first color and static elements 244 in a second color. This allows the developer a quick visual clue of the elements that have not been processed.

Thus there has been described a system and method that allows data conversion from back end office systems (e.g., relational databases) to XML and from XML to back end office systems. The tool is not limited to conversion to and from XML but can be used between any two data systems such as a relational database to an object oriented database. For the XML case the system provides an easy to use wizard that steps a user through almost the same steps whether they are converting data into XML or XML into data. The system is highly versatile and can be used for a number of different applications.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A system for converting data in a first hierarchical data scheme into a second hierarchical data scheme, comprising:
a template defining the second hierarchical data scheme;
a dynamic data generation module contained in the template; and
a data source, in communication with the dynamic data generation module, containing data in the first hierarchical data scheme.

2. The system of claim 1, wherein the template and the dynamic data generation module are contained in a server.

3. The system of claim 2, further including a driver connected between the dynamic data generation module and the data source.

4. The system of claim 3, further including a developer module contained in the server for creating the dynamic data generation module.

5. The system of claim 1, wherein the template is a static extensible markup language document.

6. The system of claim 1, wherein the template is an extensible markup language document type definition.

7. The system of claim 1, wherein the template is an extensible markup language schema.

8. The system of claim 1, wherein the first hierarchical data scheme is selected from the group of: extensible markup language schemes, relational databases, non-relational databases, extensible markup language databases and self describing databases.

9. The system of claim 1, wherein the second hierarchical data scheme is selected from the group of: extensible markup language schemes, relational databases, non-relational databases, extensible markup language databases and self describing databases.

10. The system of claim 1, wherein the dynamic data generation module includes a query directed to the data source.

11. The system of claim 1, wherein the dynamic data generation module includes a data mapping between the first hierarchical data scheme and the second hierarchical data scheme.

12. The system of claim 4, wherein the developer module contains a wizard that walks a user through a process of creating the dynamic data generation module.

13. A method of converting data in a first hierarchical data scheme into a second hierarchical data scheme, comprising the steps of:
a) publishing a dynamic template in a server;
b) receiving an instruction from a client at the dynamic template;
c) executing the dynamic template; and
d) when a dynamic data generation module is executed, performing a data transfer operation that converts data in the first hierarchical data scheme into the second hierarchical data scheme.

14. The method of claim 13, wherein step (a) further includes the steps of:
a1) receiving a template;
a2) determining for each element of the template if a dynamically generated data is required;
a3) when the dynamically generated data is required, receiving a data source for obtaining the dynamically generated data.

15. The method of claim 14, further including the steps of:
a4) receiving a data mapping between the first hierarchical data scheme and the second hierarchical data scheme.

16. The method of claim 15 wherein step (a4) further includes the steps of:
i) when the first hierarchical data scheme is a non-extensible markup language and the second hierarchical data scheme is a second non-extensible markup language, creating a first data mapping between the first hierarchical data scheme and an intermediate extensible markup scheme;
ii) creating a second data mapping between the intermediate extensible markup scheme and the second hierarchical data scheme.

17. The method of claim 15, further including the step of“
a5) receiving a key associated with the data mapping.

18. A method of converting data in a hierarchical data scheme into an extensible markup language scheme, comprising the steps of:
a) receiving a static extensible markup language template;
b) determining for each element of the static extensible markup language template if a datum needs to be dynamically generated;
c) when the datum needs to be dynamically generated, receiving a data source having data in the hierarchical data scheme for acquiring the datum;
d) receiving a data map between a data element in the data source and a metatag in the static extensible markup language template; and
e) repeating steps (b) through (d) for every element of the static extensible markup language template to form a dynamic data conversion program.

19. The method of claim 18, wherein step (a) further includes the step of receiving a template selected from the group including: an extensible markup language document type definition and an extensible markup language schema.

20. The method of claim 18, wherein step (a) further includes the step of:
a1) defining an input parameter.

21. The method of claim 18, wherein step (c) further includes the step of:
c1) receiving a driver.

22. The method of claim 18, wherein step (c) further includes the step of:
c1) generating a query to the data source.

23. The method of claim 18, wherein step (d) further includes the step of:
d1) receiving a screen having a list of elements from the data source and a list of metatags from the static extensible markup language template.

24. The method of claim 18, wherein step (c) further includes the step of:
c1) displaying an incomplete version of a dynamic extensible markup language template wherein a static element is shown in a first color and a dynamic element is shown in a second color.

25. The method of claim 18, further including the steps of:
e) publishing the dynamic data conversion program to a server;
f) when a query is received at the server for the dynamic data conversion program, executing the dynamic data conversion program to form an extensible markup language document.

26. A method of converting data in an extensible markup language scheme into a hierarchical data scheme, comprising the steps of:
a) receiving a sample extensible markup language file;
b) determining for each element of the sample extensible markup language file if a datum needs to be dynamically processed;
c) when the datum needs to be dynamically processed, receiving an extensible markup language element location for acquiring the datum;
d) receiving a data map between a metatag in the sample extensible markup language file and an element of the hierarchical data scheme; and
e) repeating steps (b) through (d) for every element of the sample extensible markup file to form a dynamic data conversion program.

27. The method of claim 26, wherein step (a) further includes the step of:
a1) defining a key.

28. The method of claim 26, wherein step (d) further includes the steps of:
d1) receiving a query type;
d2) generating a query.

29. The method of claim 28, wherein step (d1) further includes receiving an insert query type.
